(19) United States
(12) Patent Application Publication
(10) Pub. No.: US 2007/0108841 A1
(43) Pub. Date: May 17, 2007

(54) External power distribution architecture of a power supply

(75) Inventor: Chin-Szu Lee, Xindian City (TW)

Correspondence Address: BIRCH STEWART KOLASCH & BIRCH, PO BOX 747, FALLS CHURCH, VA, 22040-0747, US

(73) Assignee: TOPOWER COMPUTER INDUSTRIAL CO., LTD.

(21) Appl. No.: 11/272,755

(22) Filed: Nov. 15, 2005

(51) Int. Cl. H02J 3/14; H02J 1/00

(52) U.S. Cl. 307/31

(57) ABSTRACT

An external power distribution architecture of a power supply, wherein the existing DC voltages V1, V2 transformed from AC by the power supply are further transformed into the power used by external electronic devices plugged in external power ports. In the present invention, two different levels of DC voltages V1, V2 transformed by the power supply are defined to be voltage sources, and two different levels of target DC voltages V3, V4 output by the external power ports are respectively derived from the DC voltage sources V1, V2 closest to corresponding target voltages V3, V4. Thereby, the present invention can balance power output and reduce transformation power loss.

### FIELD OF THE INVENTION

The present invention relates to an external power distribution architecture of a power supply, particularly to an architecture, which transforms an existing DC output by a power supply into the powers used by external electronic devices plugged in external power ports.

### BACKGROUND OF THE INVENTION

In general, a current power supply provides three specifications of power outputs, including 12V, 5V, and 3.3V power output ports, for various electronic devices inside the computer system, such as hard drives, CD-ROM drives, CD-R/CD-RW burner, the motherboard, floppy disc drives, built-in speakers, etc.

Owing to the advance of science and technology, particularly owing to the rapid technology development in the Internet and multimedia, the output power of a power supply grows higher and higher, and a power output as high as 500 W has become a universal power supply specification. The reason why the power output rises to such a high level is usually to meet the need of installing more electronic devices inside a computer. In current designs, a power supply is disposed inside a computer; therefore, only the electronic devices installed inside the computer or the detachable electronic devices installed on the mount racks of the computer can really use the power supply. Obviously, the power voltages those electronic devices can use are limited to 12V, 5V, and 3.3V.

The voltage levels that many electronic devices use are different to the voltage levels provided by the power supply. In addition to a power supply, many peripheral electronic devices usually have transformers (or rectifiers) plugged in commercial power sockets; thus, the sockets near the computer are usually full of cables, transformers and adaptors, which not only influence the view but also inconvenience the user. Those electronic devices include monitors, network adaptors, wireless routers, and external speakers. Those electronic devices usually operate synchronically with the computer; however, the user would not turn off the powers of those electronic devices one by one even after the computer has been turned off. Therefore, in addition to the untidiness of their cables, those electronic devices are always maintained standby and consume vain power.

The patent U.S. Pat. No. 6,875,052 discloses a “Remainder Electric Power Distributing Device of a Computer” to solve the abovementioned problems, wherein the power of the power supply is transferred to external power ports and used by external electronic devices. However, the current power supply can only directly transfer a single level voltage (usually 12V) of the existing transformed DC to external power ports via connection cables. Therefore, the voltage of the external power ports is the same as the existing voltage of the power supply and cannot meet the voltage demands of various electronic devices.

### SUMMARY OF THE INVENTION

The primary objective of the present invention is to provide an external power distribution architecture of a power supply to overcome the abovementioned problems, wherein multiple sets of external power ports with different target voltages are provided; to reduce the power loss in voltage transformation, the DC target voltages output by the external power ports are respectively derived from the DC voltage sources closest to the corresponding DC target voltages; thereby, the voltage source of the power supply can be transferred to the external power ports with the least transformation power loss.

Another objective of the present invention is to provide an external power distribution architecture of a power supply, which can cooperate with the power supply having multiple sets of transformers to achieve a balanced power output.

### BRIEF DESCRIPTION OF THE DRAWINGS

FIG. 1 is a block diagram showing the circuitry of a first embodiment of the present invention.

FIG. 2 is a block diagram showing the circuitry of a second embodiment of the present invention.

FIG. 3 is a block diagram showing the circuitry of a third embodiment of the present invention.

### DETAILED DESCRIPTION OF THE PREFERRED EMBODIMENTS

The detailed description and technical contents of the present invention are to be stated below in cooperation with the drawings.

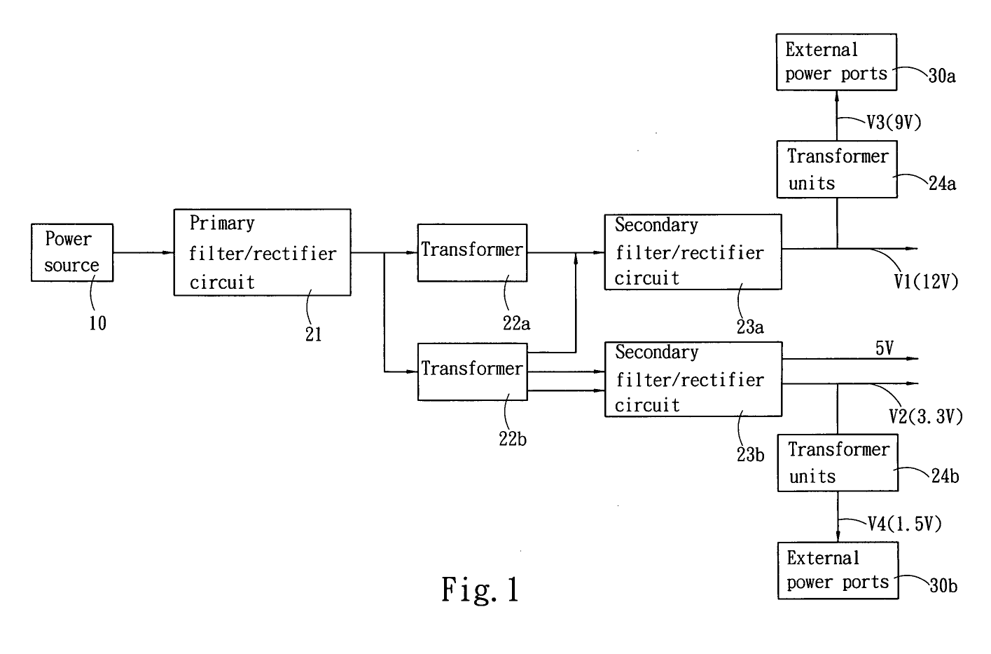

Refer to FIG. 1 a block diagram showing the circuitry of a first embodiment of the present invention. The present invention is an external power distribution architecture of a power supply, which primarily applies to a power supply transforming an alternating current into direct currents. The embodiments of the present invention are to be exemplified by the power supply, wherein multiple transformers 22a, 22b creates different levels of DC voltages V1, V2. In the existing power supply, the AC current from a power source 10 is transformed into a DC power by a primary filter/rectifier circuit 21, and then, the DC power is transformed into at least two different levels of DC voltages V1, V2 by transformers 22a, 22b and rear secondary filter/rectifier circuit 23a, 23b. Usually, the voltage levels output by a power supply are 12V, 5V, and 3.3V, and the embodiments described below will take 12V as V1, and 3.3V as V2. Herein, the DC voltages V1, V2 are defined to be voltage sources. At least two external power ports 30a, 30b are electrically coupled to the power supply and are of different voltage levels, and target DC voltages V3, V4 output by the external power ports 30a, 30b are respectively derived from the DC voltage sources V1, V2 closest to the corresponding target voltages V3, V4. The external power ports 30a, 30b are disposed on an external panel of the power supply or disposed on the casing panel of a computer in order to provide electric connection ports for external electronic devices.

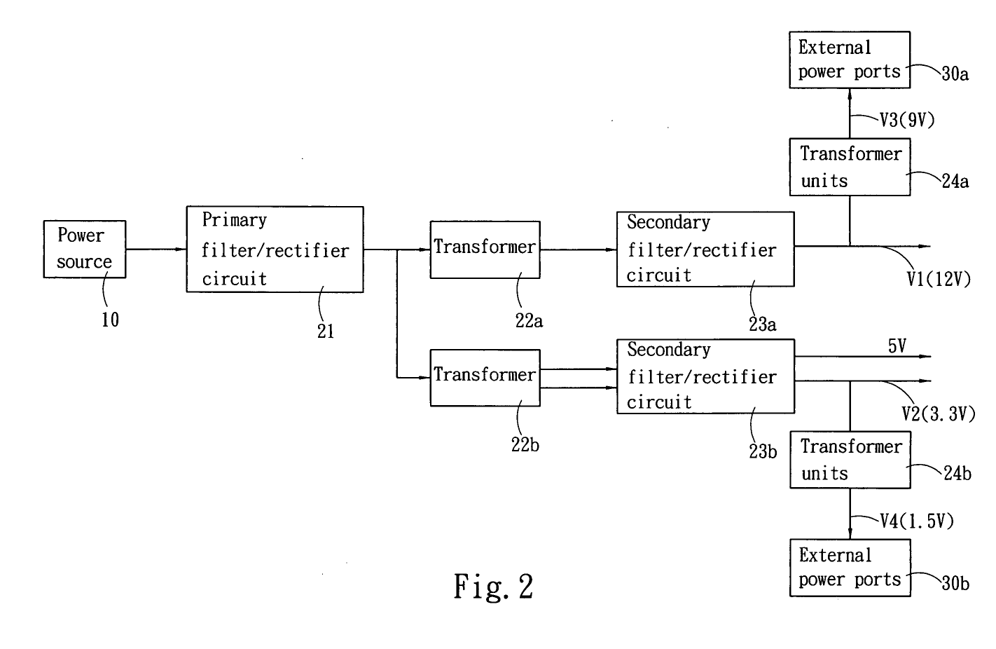

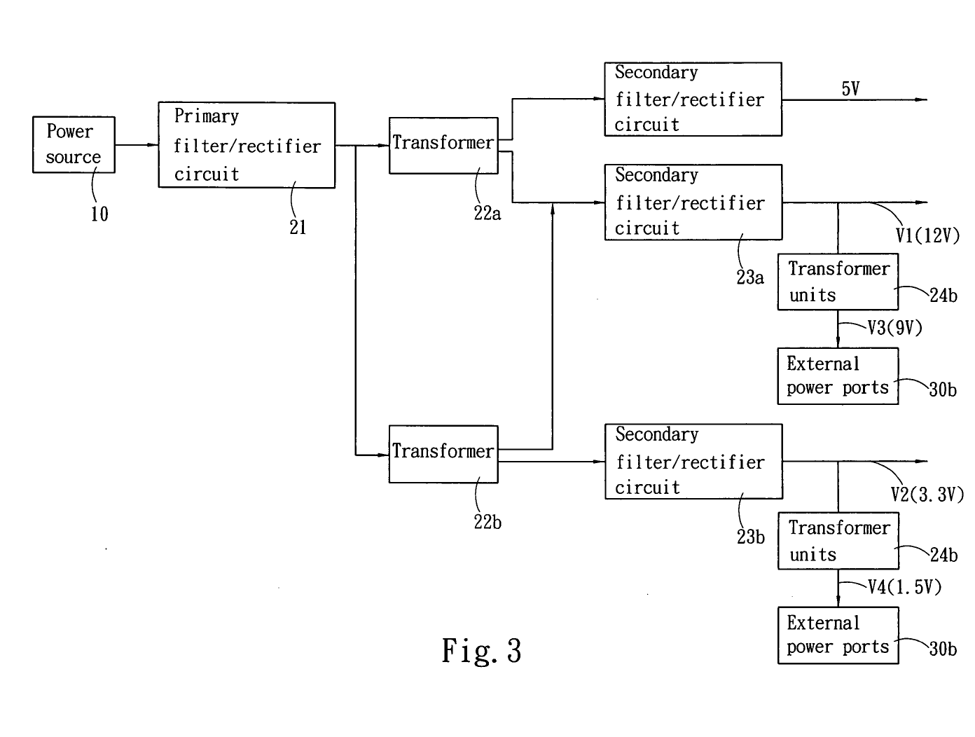

In current technology, the power supply with multiple set of transformers 22a, 22b has different circuitries. FIG. 1 shows the circuitry of a first embodiment, wherein the single transformer 22a outputs a single DC voltage V1, and another transformer 22b simultaneously outputs multiple different DC voltages V1, V2, and the DC voltages V1 are parallel output. FIG. 2 shows the circuitry of a second embodiment, and the difference between FIG. 1 and FIG. 2 is that the transformer 22b in FIG. 2 simultaneously outputs multiple different DC voltages V2 with the DC voltage V1 excluded therefrom. FIG. 3 shows the circuitry of a third embodiment, wherein both the transformers 22a, 22b simultaneously output multiple different DC voltages V1, V2, the DC voltages V1 are parallel output.

In the present invention, no matter which kind of circuitry is used, the target DC voltages V3, V4 output by the external power ports 30a, 30b can be respectively derived from the DC voltage sources V1, V2 closest to the corresponding target voltages V3, V4. The target DC voltages V3, V4 may be equal to or unequal to the DC voltage sources V1, V2. When the target DC voltages V3, V4 are unequal to the DC voltage sources V1, V2, transformer units 24a, 24b are respectively installed between the DC voltage sources and the external power ports 30a, 30b in order to transform the voltage sources V1, V2 into the target voltages V3, V4. When the present invention applies to the power supply formed of multiple transformers 22a, 22b, the loads of the transformers 22a, 22b are equilibrated so that the power load can be balanced. As the target DC voltages V3 (9V), V4 (1.5V) output by the external power ports 30a, 30b are transformed from the closest DC voltage sources V1 (12 V), V2 (3.3V) of the power supply, the transformation power loss is reduced, and the power supply can perform at higher efficiency. The present invention can apply to various external electronic devices, particularly to those operating synchronically with the computer, i.e. beginning operating when the computer is turned on, and stopping operating when the computer is turned off, such as monitors, network adaptors, wireless routers, and external speakers. Thus, the present invention can prevent the vain power consumption resulting from that the rectifiers of the external electronic devices are maintained standby after the computer has been turned off.

Those described above are not intended to limit the scope of the present invention but only to be the preferred embodiments of the present invention. Any equivalent modification and variation according to the spirit of the present invention is to be included within the scope of the present invention.

What is claimed is:

1. An external power distribution architecture of a power supply, comprising:
a power supply, transforming an alternating current (AC) into direct currents (DC), and creating at least two different levels of DC voltages V1, V2, with said DC voltages V1, V2 defined to be voltage sources;
at least two external power ports, having different voltage levels, and electrically coupled to said power supply, with target DC voltages V3, V4 output by said external power ports respectively derived from said DC voltage sources V1, V2 closest to said target voltages V3, V4.

2. The external power distribution architecture of a power supply according to claim 1, wherein said target DC voltages V3, V4 are equal to said DC voltages V1, V2.

3. The external power distribution architecture of a power supply according to claim 1, wherein said target DC voltages V3, V4 are unequal to said DC voltages V1, V2.

4. The external power distribution architecture of a power supply according to claim 1, wherein transformer units are respectively installed between said DC voltage sources V1, V2 and said external power ports in order to transform said voltage sources V1, V2 into said target voltages V3, V4.

5. The external power distribution architecture of a power supply according to claim 1, wherein said power supply utilizes multiple transformers to create at least two different levels of DC voltages V1, V2.

6. The external power distribution architecture of a power supply according to claim 1, wherein said external power ports are disposed on an external panel of said power supply.

7. The external power distribution architecture of a power supply according to claim 1, wherein said external power ports are disposed on the casing panel of a computer.
